(19) United States
(12) Patent Application Publication
(10) Pub. No.: US 2021/0223082 A1
(43) Pub. Date: Jul. 22, 2021

(54) IN-LINE MEASUREMENT OF FILL SYSTEM

(71) Applicant: AMGEN INC., Thousand Oaks, CA (US)

(72) Inventors: Joseph BERNACKI, Los Angeles, CA (US); Daniel MARSIGLIO, Thousand Oaks, CA (US); Nitin RATHORE, Thousand Oaks, CA (US)

(73) Assignee: AMGEN INC., Thousand Oaks, CA (US)

(21) Appl. No.: 17/056,469

(22) PCT Filed: Jun. 6, 2019
(86) PCT No.: PCT/US2019/035692

§ 371 Date: Nov. 18, 2020

Related U.S. Application Data
(60) Provisional application No. 62/681,909, filed on Jun. 7, 2018.

(51) Int. Cl. G01F 11/12; G01F 13/00; G01F 22/02

(52) U.S. Cl. CPC G01F 11/125; G01F 22/02; G01F 13/006

(57) ABSTRACT

The field of the invention relates generally to filling containers with liquid. More specifically, the invention relates to the real-time assessment of the volume filled into containers, particularly in the manufacture of medicaments such as pharmaceuticals. The invention finds specific use in the final stage of drug manufacturing known as fill/finish wherein the drug substance or active pharmaceutical intermediate is prepared as a final drug product in a formulation suitable for administration to patients in need of the same, which is then provided to patients. More particularly, the invention relates to controlling the volume in container via in-line non-destructive monitoring of the fill process.

This application claims the benefit of U.S. Provisional Application No. 62/681,909 filed Jun. 7, 2018, which is hereby incorporated by reference.

### FIELD OF THE INVENTION

The field of the invention relates generally to filling containers with liquid. More specifically, the invention relates to the real-time assessment of the volume filled into containers, particularly in the manufacture of medicaments such as pharmaceuticals. The invention finds specific use in the final stage of drug manufacturing known as fill/finish wherein the drug substance or active pharmaceutical intermediate is prepared as a final drug product in a formulation suitable for administration to patients in need of the same, which is then provided to patients. More particularly, the invention relates to controlling the volume in container via in-line non-destructive monitoring of the fill process.

### BACKGROUND OF THE INVENTION

Described herein are equipment, processes, and methods through which in-process monitoring of fill weight accuracy of a clinical or commercial drug product fill/finish process may be carried out using in-line pressure data. Current process controls rely on gravimetric testing of a small subset of filled units, typically 1 or 2% of the lot. In addition, lot release testing often includes deliverable volume testing to further demonstrate adequate volume in the container to ultimately enable successful administration of the product to patients. These in-process fill weight checks and laboratory deliverable volume checks are non-ideal in that they are destructive, invasive, slow, and incomplete.

Offline deliverable volume testing is destructive of the units tested and wasteful in that it often consumes secondary packaging components (e.g., plunger rods for pre-filled syringes), primary container components (e.g., empty syringes to extract and then expel volume from a vial), and/or laboratory consumables (e.g., disposable weigh vessels). In-process fill weight checks may also be destructive in the same manner if the fill weight is checked by the deliverable volume method; note that this methodology is an imperfect approach for in-process fill weight checks, since it does not directly account for any hold-up volume (defined as the volume left in the container after administration). Non-destructive in-process fill weight checks are preferable since they do not impact yield, but they are often invasive and disruptive to the filling process. One approach for non-destructive at-line testing comprises operators traceably removing empty primary containers from the filling line, weighing them, recording the empty weights, and then returning them to the filling line to be filled; once filled, the same units are removed, weighed, and returned for further processing (e.g., container closure). This methodology is an improvement over destructive testing, but it is highly invasive to the fill-finish operation—a particular risk for aseptic processing required for parenteral products. In addition, this methodology interrupts routine production moreso than destructive extractable volume testing, thereby reducing throughput. Finally, this methodology is fully manual, and thus introduces data integrity and serialization risks (e.g., misrecorded data or misplaced containers).

Non-destructive gravimetric in-process fill weight checks can be improved via robotics and the integration of load cells or scales into the filling line. Robotic arms can manipulate the containers in an automated fashion, eliminating the need for operator intervention and thereby reducing aseptic, serialization, and data integrity risks. This sort of automated on-line testing is typically faster than manual manipulation of the containers pre- and post-filling, as well. Nevertheless, 100% sampling of in-process fill weights remains impractical for high-throughput applications with this sort of on-line methodology, since throughput would still be significantly impacted by the container manipulation. As such, only a small subset of units is typically tested even on automated robotic fillers with on-line in-process fill weight checks, necessitating robust process validation with extensive homogeneity testing. The downsides inherent to such periodic in-process fill weight checks is thus sustained in that, upon the identification of an outlier unit, all units filled since the previous good fill weight check must be segregated. And, finally, the necessitation of precise robotics and load cells or scales significantly increases the complexity of the fill-finish equipment, which may introduce associated malfunction risks and preventative maintenance costs.

Unique to the presently described equipment, processes, and methods is the measurement of in-line pressure data from the filling line itself and the utilization of these data to assess in-process fill weight. Through the use of in-line pressure data, weighing devices and any associated machine components are obviated, simplifying the filling equipment. Periodic interventions to perform in-process fill weight checks are also obviated, simplifying and expediting the process as well as reducing the aseptic risks inherent to interventions. Being in-line, data are automatically obtained for every unit filled, thereby enabling 100% assessment of in-process fill weights with no sacrifice in throughput. Moreover, this assessment would be serializable and thus traceable to individual units, per the measurement of in-line pressure data for every filling line and the assessment of data for every filling stroke. In this manner, each assessment of in-process fill weight would be uniquely traceable via its position in the fill sequence and, if applicable, via correlation to its spatial location within a package of primary container components (e.g., the row and column within a tub of syringes).

The proposed invention would therefore be a process which continuously measures pressure data from every filling line, and analyzes these data against pre-established limits. In this manner, no gravimetric in-process fill weight checks would need to be performed, nor would the filling machine need to be equipped with weight measurement equipment. This process would flag outliers for removal post-production, such that neither line stoppage nor multiunit segregation to the last known good unit would be necessary. In addition, this presently described in-process fill weight control method could provide feedback to the filler continuously, as data would be measured and analyzed for each filling stroke. Thus, the filling process would be enhanced via: additional in-process information with no impact to throughput; reduced intervention requirements to assess in-process fill weights; simplified equipment requirements; and reduced waste in terms of units destructively tested, units segregated upon outlier detection, and ancillary laboratory supplies consumed.

The proposed invention aligns to the United States Food and Drug Administration guidance on Process Analytical Technology (PAT), which encourages the voluntary development and implementation of timely measurements of product quality and process performance attributes with the goal of ensuring final product quality. The PAT framework promotes gains in quality, safety, and efficiency via: reduction in production cycle times; on-, in-, and/or at-line measurements and controls; prevention of rejects, scrap, and reprocessing; real-time release; increased automation; reduction of human error; improvement in energy and material usage; production capacity increase; facilitation of continuous processing; improved process understanding and knowledge management; and multivariate data analyses. The deliverable volume and in-process fill weight check methodologies described herein can be considered in light of the PAT framework: destructive extractable volume testing is “offline,” manual pre- and post-fill weighing is “at-line,” automated pre- and post-fill weighing is “on-line,” and the proposed invention represents the ideal state of “in-line” measurement. The proposed invention actually surpasses the PAT framework in that it represents “model-based process control,” since the in-line pressure data are correlated to the attribute of direct interest, fill volume. Successful model-based process control represents the pinnacle of process control strategy, since it directly leverages process knowledge as well as scientific and engineering understanding to most efficiently, robustly, and proactively control a given process.

### SUMMARY OF THE INVENTION

As described more fully herein, single-use pressure sensors were integrated in-line to the filling process, with the initial goal of assessing fill nozzle clogging due to product drying. These sensors were originally introduced into the laboratory as a safety device to flag over-pressurization of a fluid flow system. The sensors were indeed capable of detecting fill nozzle clogging due to product drying, in that an increase in maximum observed pressure was measured upon partial occlusion of the filling nozzle with dried product.

The in-line pressure sensors were originally integrated into peristaltic pump mediated filling systems due to the latter's increased recent usage in aseptic biopharmaceutical processing. Peristaltic pumps offer a number of unique benefits to drug product fill/finish processes, especially when compared to processes using pistons or pressurized tanks to dispense drug products. In particular, these pumps utilize disposable product contact surfaces (i.e., single-use systems), which can be superior to systems with extensive stainless steel and other reusable product contact surfaces (e.g., pressure vessels, mixing vessels, pistons, filling nozzles, etc.). While single-use systems may increase the direct process waste generated in comparison to reusable systems, the lack of clean-in-place and steam-in-place requirements can significantly reduce manufacturing infrastructure needs and ancillary material usage (e.g., cleaning fluids).

Peristaltic fillers were particularly appealing for the original intent of the in-line pressure sensors, since their mode of delivery enables robust control of the meniscus or droplet at the filling nozzle. A “reverse” or “suck-back” setting available for most peristaltic fillers rotates the peristaltic pump head backwards a small amount at the end of a filling stroke, thereby reversing flow slightly and retracting some fluid into the filling nozzle. A schematic of this motion and its effect on liquid at the filling nozzle is shown in FIG. 1 for a typical filling curve with diving needle motion. Since peristaltic filling uniquely offers this ability to control droplet formation and the meniscus at the filling nozzle, it was surmised that product drying on the filling nozzle could be mitigated.

In the course of these filling experiments, several interesting hydraulic observations were made regarding filling pump output pressure prior to the onset of fill nozzle clogging, i.e. during routine production. In particular, when varying the location of the in-line pressure sensor during peristaltic pump mediated filling, it was noted that moving the sensor away from the filling nozzle and towards the pump increased the pressure signal and revealed additional phenomena. Relative positions of the sensor in a pump and tubing assembly are shown in FIG. 2. The type of data obtained when the in-line pressure sensor is placed close to the peristaltic filling pump is displayed in FIG. 3.

These data offered an unprecedented insight into the complex flow phenomena inherent to peristalsis, and experimental investigation by varying input parameters, materials (e.g., tubings, Y-connectors, and nozzles), equipment (e.g., different pump heads dimensions), and sensor operation (e.g., data collection frequency) enabled the rationalization of features within the measured in-line pressure vs. time curve.

The persistent oscillation in the measured pressure arises naturally from peristalsis. Modern peristaltic fillers typically utilize pump heads with dual rotors offset precisely out-of-phase; flow through pump head tubing off each rotor segment is typically combined through a Y-connector into a single dosing tubing typically connected to the filling nozzle. This approach is said to dampen the oscillatory flow inherent to peristalsis, but the observed in-line pressure data indicates that significant fluctuation in flow persists even with this offset rotor strategy. Moreover, the apparent “superstructure” to the oscillation rather than a visually consistent oscillation was unexpected and not immediately explicable. The acceleration and deceleration of the pump rotors are not typically considered in detail, but their effects are clearly observable in the ramp-up and ramp-down of the pressure curve. Finally, the reverse setting has a distinct impact on the flow, manifesting as a negative region within the pressure curve and indicating significant backwards flow at the end of the filling stroke.

In addition to enabling the rationalization of the newly-available in-line pressure data from the filling stroke, experimental investigation revealed important correlations between features of the in-line pressure data and the fill process. Notably, the maximum pressure was clearly correlated to the speed of the peristaltic pump head rotation and clearly not correlated to the volume delivered by the filling stroke, shown in FIG. 5 The correlation of the maximum in-line pressure reading to the peristaltic pump speed provides value during process design in a direct and an indirect manner. The tubing assemblies used are typically comprised of multiple tubings and nozzles; the different tubings are typically coupled via Y-connectors, and the tubing-Y and tubing-nozzle connections are typically reinforced with cable tie-type fasteners. These cable tie-type fasteners typically have safe pressure ratings beyond which risks of leakage or disconnection might manifest, and the in-line pressure data thus enables an assessment of this risk during process design. The maximum in-line pressure should correlate to the flowrate per the Hagen-Poiseuille equation, and it is known that the flowrate during filling must be neither too high nor too low to ensure a “clean fill” (e.g., no splashing, no foaming, no dripping, etc.). While precise quantitative a priori prediction of the necessary flowrate to achieve a clean fill is beyond the current state of the art, the maximum in-line pressure measurement adds an additional quantitative tool to the process engineer designing a robust filling process.

Correlating the in-line pressure data to the fill volume was viewed as particularly valuable, given the criticality of volume as an attribute and the challenges and waste of executing in-process fill weight checks and deliverable volume release testing. The correlation would need to be very strong, given the high precision needed for pharmaceutical drug product volumes. In-line pressure data were collected for filling strokes wherein the fill weights were also directly measured, and the data were analyzed in an exploratory manner. Thus, it was discovered that the areas under the in-line pressure data curves were correlated with the gravimetrically measured fill weights. The correlation is very strong, and linearly spans the experimentally-tested range.

This strong and monotonic correlation would enable the unambiguous determination of fill weight for a filling stroke based only on in-process fill weight data. This would be specifically done by calculating the area under the pressure-time curve (e.g., via the trapezoidal rule) and estimating the fill weight via a previously-established standard for the filling system in question. The fill volume could then be readily estimated per the previously-established density of the fluid being filled. This approach could obviate the need for destructive extractable volume testing as well as the need for on-line or at-line gravimetric fill weight checks, and could conceivably replace all in-process controls and release testing as an in-line realtime release test (RTRT) for the volume quality attribute.

Though the discovery was made with peristaltic pump filling technology, the concept should apply to any filling technology. In particular, this in-line pressure sensor could be readily utilized in other filling technologies used in the drug product process such as: “time-over-pressure” filling, in which the transfer is mediated by the timed opening of a pressurized surge vessel; and positive displacement filling systems, such as rotary piston pump filling and piston pump filling. The pressure sensor could be placed immediately downstream of the key driving and control point of the fill system—the pinch valve for time-over-pressure filling and the pistons for rotary piston and piston pump filling—and the data could be collected, analyzed, and utilized in a completely analogous fashion to the description here. The fine details of the pressure curve—including but not limited to the maximum pressure, overall shape, ramp-up and ramp-down, oscillatory behavior or lack thereof, and negative pressure region or lack thereof—are liable to be different for each filling technology, but the strong correlation between the area under the curve and the fill volume should persist across technologies.

Given the correlation between fill weight and area under the pressure curve as well as the ability to rationalize features of the pressure curve via systematic experimentation, it was surmised that information contained within the pressure data could provide insight into the physical state of the pump head tubing. Peristaltic filling equipment vendors recommend a “break-in” period prior to the commencement of filling operations, meaning running the pump head with the tubing installed for some duration prior to calibrating the pump for the proper filling of units. The benefits of this break-in have been corroborated anecdotally by characterization and manufacturing experience, in that the controller seems to be better able to quickly calibrate fill weight and commence routine operation without incident if the tubing is broken-in. But, the recommendations are inconsistent amongst vendors, in terms of the necessary duration and operating conditions, particularly the pump speed and whether “dry” vs. “wet” break-in—i.e., break-in with the tubings empty vs. break-in with the tubing filled with product and thus driving flow through the system—is preferred. Wet break-in is particular non-ideal in that product is flushed rather than filled into units, negatively impacting yield. In addition, the materials science and viscoelastic phenomena underpinning the benefits of break-in have not been established in the literature.

The ability of the in-line pressure sensor to illuminate the impact of break-in on tubing performance was explored. A new (i.e., non-broken-in) tubing assembly was put into the pump head, and routine operation was commenced immediately in a characterization setting. Both in-line pressure sensor data and gravimetric fill weight data were gathered as the number of fill strokes increased. Rather than the very strong correlation between fill weight and area under the pressure curve observed for broken-in tubing, the correlation for new tubing was quite poor: coefficient of determination or r² of 0.4. Interestingly, the correlation improved with increasing number of strokes, reaching an r² of 0.9 by the end of the experiment. These data are provided in FIGS. 7A and 7B. Thus, the strength of the correlation between fill weight and area under the pressure curve seems to align to the breaking-in of the tubing. This observation indicates that tubing performance can be directly and quantitatively monitored in a non-invasive manner. Via this discovery, the need for dedicated tubing break-in could be obviated via the use of the in-line pressure sensor and data analysis. The fill weight could be directly verified by in-process fill weight checks until the correlation between fill weight and area under the pressure reaches a previously-established threshold. Once this threshold is reached, routine operation could commence with full confidence that the tubing has been properly broken-in.

Finally, it is surmised that the in-line pressure sensor can be used to monitor the overall health of the filling system in situ. Typically, processes are directly validated for an explicitly-demonstrated duration, among other critical process parameters, and are observed and controlled via various in-process controls. Operators also monitor the process in an ad hoc fashion, and have the mandate to open a nonconformance upon the observation of a process deviation. The in-line pressure sensors comprise a novel, direct, and quantitative avenue to assess process performance. A process signature or fingerprint could be established during process validation, in the form of the pressure curve and key features of it (e.g., the maximum pressure), and the process can be routinely monitored against this fingerprint into the future. The primary potential application envisioned would be to assess tubing health during long batches, and enable tubing replacement or batch cessation prior to catastrophic tubing failure.

It is surmised that tubing wear might manifest in identifiable features of the pressure curve, e.g. weakened fill weight vs. area under the curve correlation, reduced maximum pressure, lengthened fill stroke duration, or other changes in the shape of the curve. It is also surmised that other failure modes or process risks might manifest in the pressure curve data, including but not limited to: a change in the spring force in peristaltic pump heads that contain a spring; a loosening or disconnection of the pump head in peristaltic pump heads with a fixed compression; product leakage at connections or via inadvertent holes in the tubing assemblies; air bubbles in the fluid stream arising via air entrainment or outgassing of dissolved gases; a kink or other obstruction in the fluid flowpath; and/or product drying at the nozzle tip obstructing flow at the flowpath outlet. This proactive and innovative data gathering and analyses align to the PAT framework, and comprises a novel example of “fault detection and classification.” This fault detection and classification will enable more robust process control, reduce risk, and indicate process improvements.

### BRIEF DESCRIPTION OF THE DRAWINGS

FIG. 1 shows the typical fill curve for a liquid dispense of a peristaltic pump, showing liquid motion at the nozzle. As the filling needle dives into the primary container, the pump activates in the forward direction of rotation. When the dispense has completed, the pump reverses direction so that some product may be withdrawn back into the needle.

FIG. 2 shows the Peristaltic pump and tubing set-up showing optional sensor placements. The sensor was initially placed (1) near the filling nozzle, and then moved closer to the pump (2).

FIG. 3 is a graph showing the typical pressure vs. time output of the sensor capturing a filling stroke.

FIG. 4 is a graph showing the Pressure vs. Time outputs for various delivered volumes at common pump parameters. Peak pressure is not strongly indicative of dose, rather, it is a result of system geometry and pump parameters

FIG. 5 is a graph showing the pressure output for individual filling strokes for a range of pump speeds, dispensing a common dose volume.

FIG. 6 is a graph showing the integrated area-fill weight correlation for a range of fill weights, with a line of best fit

FIGS. 7A & FIG. 7B are graphs showing the progression of the area-fill weight correlation as the pump tubing is used. After the tubing was installed in the peristaltic pump, the initial 20 dispenses were captured using the pressure sensor in set 1, after which 100 fills were performed without collecting data. This pattern was repeated for sets 2, 3, and 4.

FIG. 8 In-line pressure data from representative time-over-pressure filling.

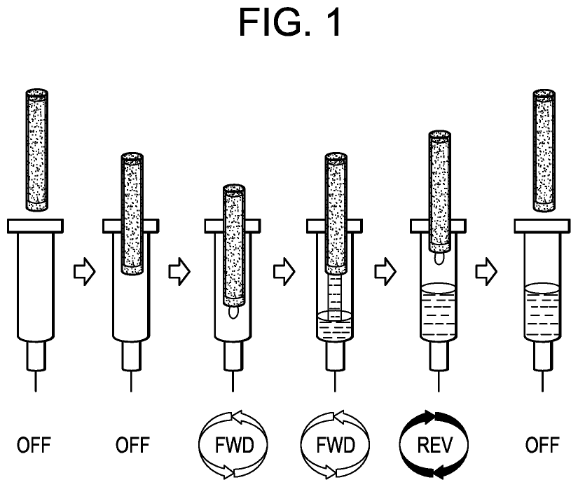

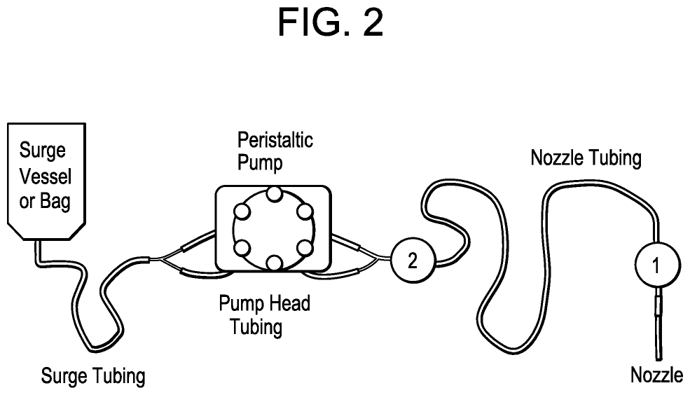

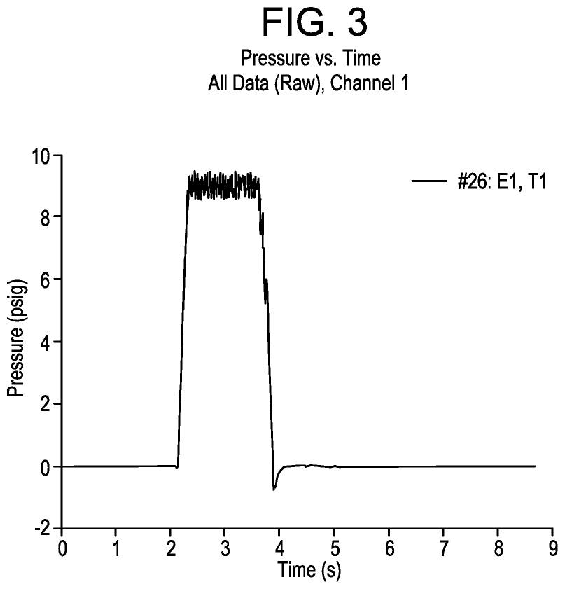

### DETAILED DESCRIPTION

Described herein are equipment, processes and methods through which in-process monitoring of fill weight accuracy of a clinical or commercial drug product fill/finish process may be carried out using in-line pressure data.

Pumps can be used according to the invention that have different mechanical properties. While peristaltic pumps are provided in the current examples, additional pump systems are contemplated within the scope of the invention.

Peristaltic pumps are understood to include a type of positive displacement, where flexible tubes are fitted inside a circular pump casing. A rotor with lobes, rollers, shoes, or the like are attached to the external circumference of the rotor; these then compress or pinch the flexible tubing and, upon rotor rotation, these physical compressions/pinches force the fluid to flow or pump through the tubing. The compression of the tubing can either be fixed or variable, with the latter mediated by an adjustable spring within the pump head. Further, as the tube opens back to its natural uncompressed state after the passing of the cam, fluid flow is induced to the pump. The process as a whole is known as peristalsis. One of skill the art will recognize many variations of pump systems that will be compatible with the current invention. Other filling systems regularly utilized during the filling of liquid products will be compatible with the current invention, including other positive displacement pumps such as rotary piston and piston pump as well as time-over-pressure systems, which operate via the timed opening of a pressurized vessel.

Single-use pressure sensors were integrated in-line to the filling process, with the goal of assessing fill nozzle clogging due to product drying. These sensors are typically used in the laboratory as a safety device to flag over-pressurization of a fluid flow system. Through lab-scale filling experiments, several hydraulic observations were made regarding differences in pump output pressure, and the sensors became a source of lab data to track filling performance. For example, placing the sensors very near the filling nozzle provided quantitative data for drug product drying and clogging phenomena, as partially occluded nozzles dispensed material through a smaller flow orifice and saw an increase in line pressure. Eventually, a baseline understanding of pump outputs was obtained, such that pressure measurements could be taken very near the pump outlet and data rationalized to assign features to visualizations of pressure over time.

Another method of fluid transfer involves pressurizing the headspace of a stainless steel tank with an inert gas or compressed air, with an outlet manifold of flexible tubing enabling filling into the primary container. This tubing passes through a pinch valve, or pincher, which opens and closes to effectively modulate the amount of liquid driven out of the tank by the headspace pressure. The filling approach is referred to as “time-over-pressure” filling and is used throughout the drug product fill-finish industry.

### Examples

The following examples, both actual and prophetic, are provided for the purpose of illustrating specific embodiments or features of the present invention and are not intended to limit its scope.

For peristaltic filling examples utilized sections of flexible platinum-cured silicone tubing fed through a peristaltic pump, dispensing deionized water from a stainless steel nozzle into a laboratory beaker. This beaker was placed on a laboratory balance and tared before peristaltic filling fill, in order to capture the fill weight of peristaltic filling pump stroke. One experimental set-up using a laboratory-scale Flexicon filling system included surge vessel connections which required 5″ of 4.8 mm I.D. tubing to connect to vessel barb. After the first sensor (barb fittings), 2″ of 4.8 mm I.D. tubing fed a reducer, which was connected to the remaining 17″ of 0.125″ I.D. surge vessel tubing before the first Y-connector. Pressure sensors were located 5″ downstream of surge vessel, 2″ downstream of second Y-connector, and 2″ upstream of nozzle. To begin peristaltic filling experiment, the following procedure was executed:

Set velocity (300 RPM) and acceleration (200, in proprietary units) and dry run for 2 minutes to break in tubing;

Set reverse (5, in proprietary units) and prime tubing;

Calibrate pump for chosen volume;

Perform 20 fills and record fill weights and pressure sensor data, varying the location of the pressure sensor across experiments;

Perform many additional fills (e.g., 100) before repeating 20 fill weight measurements.

TABLE 1
List of peristaltic filling set-up components

| Item | Manufacturer |
|---|---|
| Pt-cured silicone tubing, various diameters | Flexicon |
| Stainless steel nozzles | Flexicon |
| Pressure sensors | Pendotech |
| PD12L peristaltic pump | Watson Marlow |
| MC12 pump controller | Watson Marlow |
| Luer fittings | various |
| Y-connectors, 1.6 mm I.D. | various |

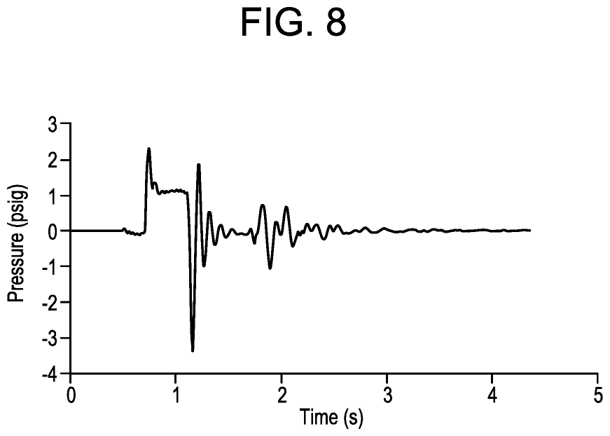

Another example with a pilot-scale time-over-pressure filling system utilized sections of silicone tubing with the in-line pressure sensor placed downstream of the pinch valve. The full length of tubing from the pressure vessel to the filling nozzle was 36″, with the pinch valve approximately 7.5″ from the vessel and the pressure sensor 14″ downstream of the pressure vessel. The silicone tubing had 2.4 mm I.D. and 7.1 mm O.D. The automated and integrated calibration and control logic on the pilot-scale time-over-pressure equipment was used, with settings approximately analogous to those used during routine manufacturing. As for the peristaltic filling experiments, 20 fills were measured via both routine fill weight checks and the in-line pressure sensor (see FIG. 8).

TABLE 2
List of set-up components for time-
over-pressure filling experiments

| Item | Manufacturer |
|---|---|
| Silicone tubing, various diameters | Saint-Gobain |
| Stainless steel nozzles | Groeninger |
| Pressure sensors | Pendotech |
| Luer fittings | various |
| WDM3100 pilot-scale time-over-pressure | Bausch + Ströbel |
| filling system | |

### Results

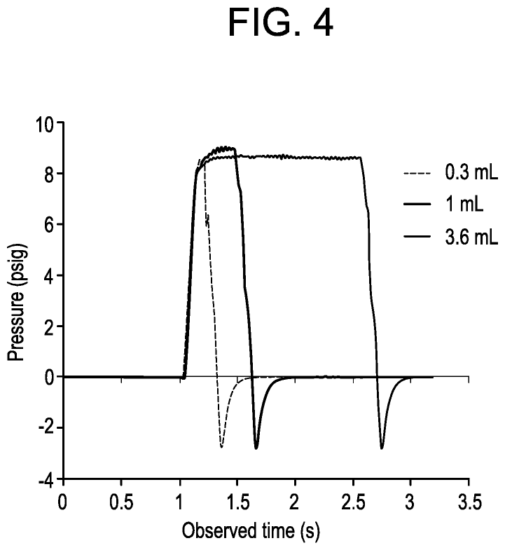

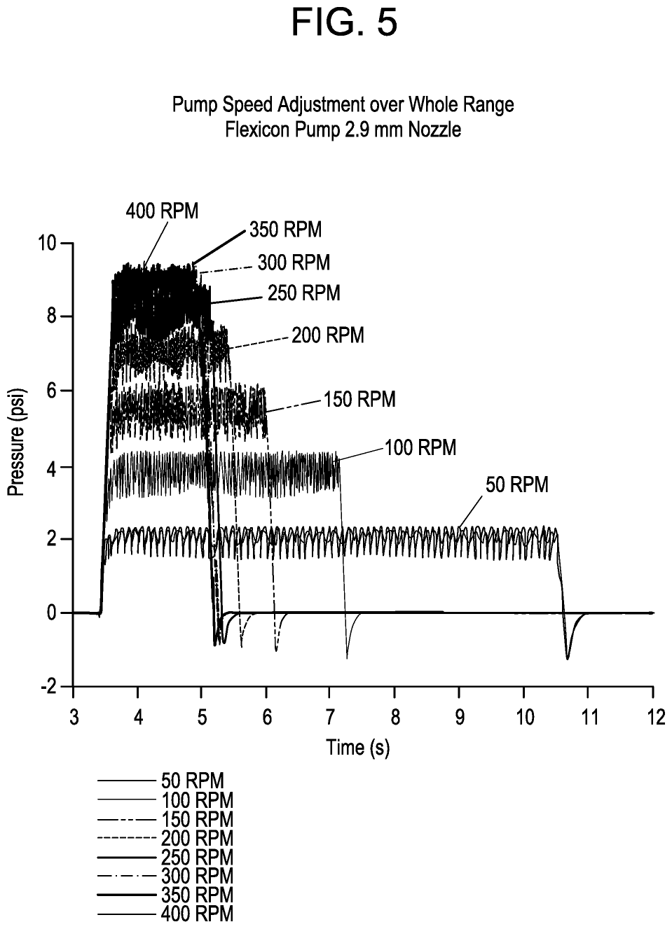

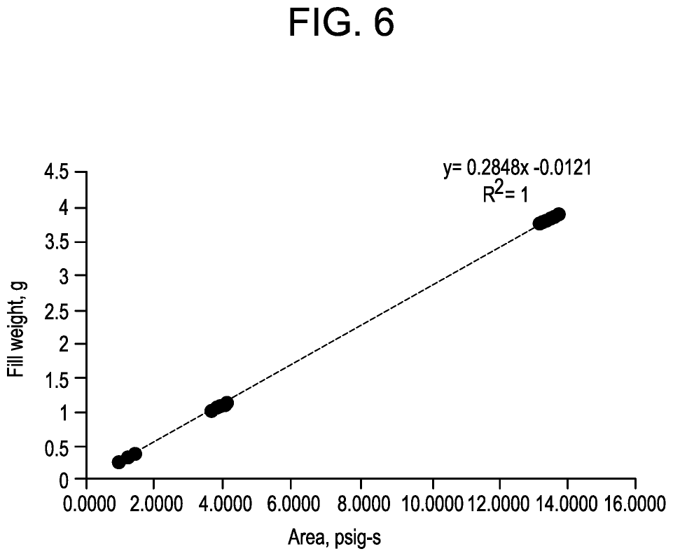

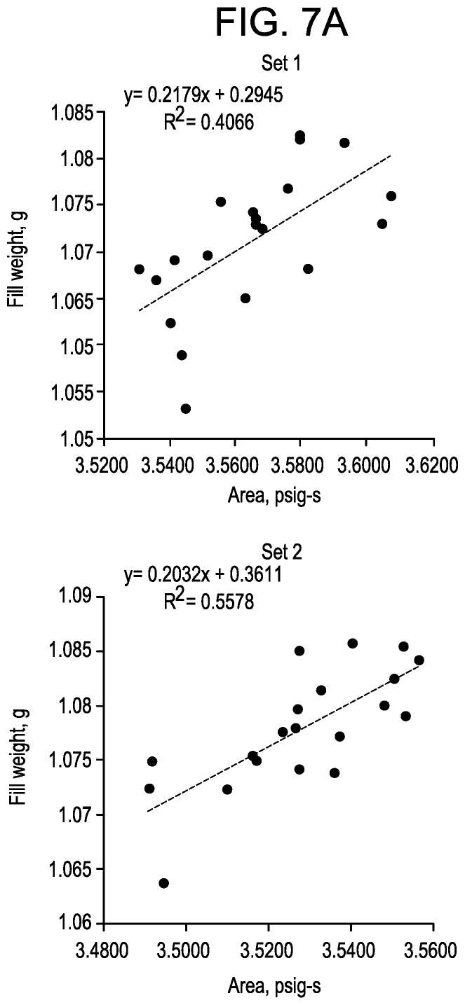

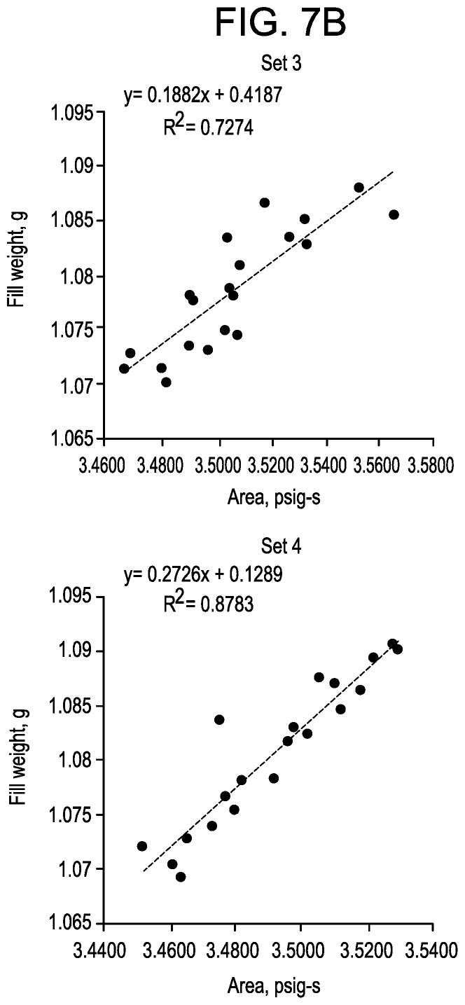

From fluid flow theory for flow through a pipe, system pressure drop is directly proportional to flow rate, and, in fill/finish manufacturing, fill volume is a parameter of particular interest. As fill volume is itself an artifact of the flow rate, it is likely that fill weight is also correlated to system pressure drop. However, peristaltic pump rotor motion is typically governed by a programmed speed and acceleration, such that a maximum pressure is reached for all dispenses above a certain fill volume. The pump pressure output oscillates at a certain value until the dose has been dispensed; a larger fill volume would not result in a larger pressure output for the same programmed settings. In this way, a direct correlation between fill weight and pressure drop was not clear from the maximum pressure alone. From experiment, peak pressure itself is not strongly representative of dosing volume. A comparison of several delivered volumes at common pump settings is shown in FIG. 4.

One approach towards higher pressure data resolution between dispense volumes is utilizing the differences in area under the pressure curves themselves. To perform this task, standard software packages (e.g., Microsoft Excel and Matlab from MathWorks) were used to prepare spreadsheets and scripts to analyze the pressure data, particularly applying the trapezoidal rule of calculus to integrate the area under the curve. This result, in psig-seconds per the units of measure of the in-line pressure sensor, can be plotted for typical alert and action limits for a target fill. This is of particular importance to manufacturing, where very tight statistical process control is necessary: alert limit excursions typically drive process adjustments, action limit excursions typically trigger nonconformances, and the process is monitored against process performance index (Ppk) expectations and for Nelson rule violations. may be utilized. For example, when doing so for fills of 0.3, 0.25, and 0.35 mL, distinct differences in area can be discerned, such that an area measurement from fills outside of these limits could easily be flagged as outliers.

There is a gap of approximately 0.11 psig-s between the largest 0.3 mL area and smallest 0.35 mL area, and one of approximately 0.18 psig-s between the largest 0.25 mL area and smallest 0.3 mL area. The mean area for the 0.3 mL fills (the fill target) was 1.18 psig-s, such that these gaps represent between 9 and 15 percent of the target area. By this analysis, areas representing fill weights which are outliers can be identified easily—that is to say, relevant differences in fill weight do indeed provide relevant differences in integrated areas. To be able to apply the curve area trend in to fill weights very close to one another was a surprising result.

When target fills of 0.3, 1.0, and 3.6 mL are plotted together, a linear trendline of the data passes through the origin, confirming the reasonableness of the approach. This range of fill volumes spans a valuable number of pharmaceutical parenteral products manufactured with the filling technologies for which this invention applies, indicating significant potential value for this advance. Furthermore, it stands to reason that the trendline should continue as the fill volume increases.

The time-over-pressure experiments also indicated that differences in integrated areas could be revealed between manufacturing-relevant fill weights. The in-line pressure data from the time-over-pressure filling experiments differed from the peristaltic filling data in two key regards. First, the overall pressure was lower, with a maximum pressure less than approximately 3 psig. In addition, there was significant noise in the signal at the end of the filling stroke, likely due to the nature of the time-over-pressure filling process in which the pinch valve is abruptly closed to cease flow. Despite these complexities, the mean integrated areas for 0.95 mL, 1.0 mL, and 1.05 mL target fill volume fills were 0.43 psig-s, 0.47 psig-s, and 0.49 psig-s, respectively. Note that, for this analysis, the integration was stopped at the first negative value to avoid the noise at the end of the filling stroke. Moreover, the ranges of integrated areas for each of the 20 target fill volume trials measured did not overlap; that is, the integrated areas for all 20 target 0.95 mL fills were smaller than the integrated areas for all 20 target 1.0 mL fills, which were themselves all smaller than the integrated areas for all 20 target 1.05 mL fills.

### Tubing

Pump tubing used as part of the peristaltic pump manufacturing process can behave differently over prolonged use. New tubing is often specified to require a break-in period before manufacturing, in order to achieve an optimal stiffness and relaxation ability. However, no specific guideline is available as to how long this break-in period should last, nor is quantitative data available to track or suggest an optimal tubing lifespan.

Based upon the fill weight-area correlation discovered in the preceding section, it was surmised that information available in the pressure curve might provide insight into tubing break-in period, especially if the correlation were tracked over the prolonged use of a tubing set. To proceed, fills were dispensed for a target 1 mL fill and pressure data collected. Four sets of 20 samples were taken, however, 100 fills were dispensed in between data collection, such that set 2 comprised fills #121-140, and so on. Trapezoidal rule areas were computed and the correlations with fill weight calculated.

From the analysis, the behavior of the tubing can be seen to change over time, as the area/fill weight correlation (measured by r²) becomes more precise with additional fill strokes. These data document an important process discovery, namely, that tubing performance not only changes over time, but can be quantitatively tracked. It is possible that “break-in” periods might be able to be tracked in real time to an optimal use case. In this same manner, guidance as to when tubing should be discarded can be provided, as determined by a deterioration in the correlation.

What is claimed:

1. A method for assessing fill volume during filling of a container comprising
a) transferring formulated product from a vessel into the container while measuring hydrodynamic pressure between the vessel and the container,
b) calculating the area under the measured pressure vs. time data curve, and
c) assessing the fill volume based on a correlation of the calculation from step b) to a previously established standard.

2. The method of claim 1 wherein the volume in the container is not measured by destructive extractable volume testing.

3. The method of claim 1 wherein the fill weight in the container is not measured by at-line or on-line gravimetric fill weight testing.

4. The method of claim 2 wherein the fill weight in the container is not measured by at-line or on-line gravimetric fill weight testing.

5. The method of claim 4 wherein the assessment from step 1c) constitutes the required quality attribute testing for fill weight or fill volume, i.e. as an in-process control or as realtime release testing.

6. The method of claim 1 wherein the transfer is mediated by a peristaltic pump.

7. The method of claim 1 wherein the transfer is mediated by piston pump.

8. The method of claim 1 wherein the transfer is mediated by rotary piston pump.

9. The method of claim 1 wherein the transfer is mediated by timed opening of a pressurized surge vessel, also known as “time-over-pressure” filling.

10. A method for assessing tubing fidelity during filling of a container comprising
a) transferring formulated product from a vessel into the container mediated by a peristaltic pump while measuring hydrodynamic pressure between the vessel and the container, and
b) assessing tubing fidelity based on a correlation of measured pressure vs. time data to previously establish standards.

11. The method of claim 10 wherein tubing “break-in” is not performed, and fill volume or fill weight is otherwise verified (e.g., by gravimetric weighing) until the previously established standards are achieved.

12. The method of claim 10 wherein the process is interrupted and the tubing is replaced based on the tubing fidelity assessment.

13. The method of claim 11 wherein the process is interrupted and the tubing is replaced based on the tubing fidelity assessment.

14. A method for facilitating process understanding during filling of a container comprising
a) transferring formulated product from a vessel into the container while measuring hydrodynamic pressure between the vessel and the container,
b) leveraging these data to establish a process signature, drive continuous process improvements, and/or develop risk mitigation strategies.
